(19) United States
(12) Patent Application Publication
(10) Pub. No.: US 2012/0261212 A1
(43) Pub. Date: Oct. 18, 2012

(54) ANTI-PANIC DESCENDER WITH POSSIBILITY OF ASCENT

(76) Inventor: Marco Bonaiti, Lecco (IT)

(21) Appl. No.: 13/450,352

(22) Filed: Apr. 18, 2012

(30) Foreign Application Priority Data
Apr. 18, 2011 (IT) MI2011U000131

(51) Int. Cl. A62B 1/14; A62B 35/00

(52) U.S. Cl. 182/5

(57) ABSTRACT

The present invention consists of a descender intended to slow down and regulate the descent of a user along a cable, provided with cable blocking systems which intervene when the user releases the descender completely or grasps it in panic, characterised in that the descender also allows for ascent, making said cable transition to an opposite direction, without actuating any of the aforesaid blocking systems which would prevent said ascent.

CROSS-REFERENCE TO RELATED APPLICATION

This application claims the benefit of Italian Utility Model Application no. MI2011U000131 filed on Apr. 18, 2011 with the Italian Patent and Trademark Office (UIBM) in the name of KONG SpA.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

1. Field of the Invention. The present invention consists of a descender intended to slow down and regulate the descent of a user along a cable, provided with cable blocking systems which intervene when the user releases the descender completely or grasps it in panic, characterised in that the descender also allows for ascent, making said cable transition to an opposite direction, without actuating any of the aforesaid blocking systems which would prevent ascent.

A descender device is known, mainly made up of a support flange, preferably elongated and with a shape roughly like a spanner. On one side, two cams are placed via known means, hereinafter said upper cam and lower cam. On the other side, a lever intended for gripping the device and for operating the same, preferably composed of an appropriately shaped flange, hereinafter said regulation lever.

A pin integral with both the regulation lever and the lower cam traverses the thickness of the support flange placed between them, allowing the same to rotate together in relation to said support flange. Said regulation lever is hinged by means of another pin to a connecting rod which acts as a restraint between a shackle and said lever. Said connecting rod is hinged at the other end by means of an additional pin to said shackle. The upper cam is attached to the support flange with known means so that it cannot move in relation thereto.

Said shackle is situated just above the upper cam, and is made up of two reciprocally integral teeth, hereinafter said braking teeth, which are turned approximately on the opposite sides of a pin by means of which said shackle is constrained to rotate on the support flange. Each of said braking teeth has a somewhat curved surface on the opposite side in relation to the upper cam (the closest of the two to said shackle), while the face is provided with at least one rather sharp edge turned towards said upper cam it.

The cable with which the operator descends is inserted in the device in such a way that it can transition to said device. The cable remains adjacent to the support flange in the recesses between the two cams and between the upper cam and the shackle. The shackle is composed of the two braking teeth. In this way, the cable moves along an approximately (and at least partially) S-shaped path, hence slowing down the descent of the user, or of any mass attached to the device. The slowing down is due to the sliding friction between said cams and said cable. When the regulation lever is left in an intermediate position, the cable can slide freely, exiting on the side of the lower cam.

By rotating the regulation lever towards the support flange, the connecting rod transitions, so as to rotate the shackle. In this way, a braking tooth approaches the upper cam, thereby blocking the cable against said cam by means of the rather sharp edge, so as to wedge said cable in the recess between said shackle and said upper cam. Therefore when experiences an overly rapid descent and grips the device in panic, the device automatically blocks said descent by jamming said cable.

When the user starts at the intermediate position of the regulation lever, and releases the same or abandons the grip (free hands) so that the latter rotates externally in relation to the support flange, moving away from the same, said rotation causes the connecting rod to lower in accordance with a reference which goes from the lower cam to the upper cam. Said lowering in turn causes the shackle to rotate in a direction contrary to the direction when the device is gripped. In this way, the other tooth, in relation to the previous case, moves towards the upper cam, crushing the cable against said cam with the corresponding shaped edge, thus blocking the relative movement between said cable and device.

However, there is a disadvantage with said shackle. By moving one of the two teeth towards the upper cam alternatively on the basis of the direction of said rotation, a user seeking to ascend and intending to make the cable transition from an opposite direction, or seeking to make the cable exit from the recess between said upper cam and said shackle, would not be able to recover the cable because said movement would cause the rotation of one of the two teeth upwards and of the other downwards, so that the latter would crush the cable against the upper cam. In particular, the cable would be blocked by the tooth designed to block it in the case wherein the user grips the device.

### BRIEF SUMMARY OF THE INVENTION

The object of the present invention is therefore to provide a descender, which is intended to slow down and regulate the descent of a user along a cable, with cable blocking safety systems so that when the user completely releases the descender (free hands) or grasps it in panic, the descent is stopped; said cable blocking safety systems allowing said user to ascend and to recover said cable by extracting the cable in an opposite direction in relation to the movement of descent, without the cable blocking one of the aforesaid safety systems.

This object is achieved by eliminating one of the two braking teeth and appropriately shaping the lower cam so that it has adequate protuberance arranged so that the blocking of the cable—in the case wherein the user releases the regulation lever completely in such a way that the latter moves away from the support flange—is caused by said lower cam by means of said protuberance and no longer by said shackle. The rotation of the regulation lever externally, in relation to the support flange, as a result of releasing the lever causes the rotation of the lower cam. The lower cam is arranged in such a way as to crush the cable against the upper cam by means of the aforementioned protuberance. The aforementioned protuberance is provided with a fairly small radius of curvature, preferably at a fairly flat side of the same, so as to block the movement of said cable in relation to the device or of the device along the cable.

The presence of a single braking tooth which functions to block the cable if a user were to grip the device allows the user to recover the cable for the purpose of ascending without said cable inducing rotation upwards of the other braking tooth; said rotation upwards being in turn the cause of the rotation downwards of the opposite tooth and of the aforesaid blocking of said cable. On one side of the restraint pin with the support flange, the shackle is composed of a body comparable to a tooth, while on the other side, the shackle is made up of a structural element. The extension of the structural element along the axis of rotation of said shackle, in relation to the support flange, is fairly small so as to allow the cable to pass over the shackle without having to turn around the shackle to make the shackle rotate when recovering the cable.

Said structural element, which is preferably made up of a simple arm, acts as a restraint between said tooth and a structural element having the function of partially restraining the movement of the shackle to that of the lever and preferably made up of a connecting rod hinged by known means to said arm and to said lever. The assembly created by said connecting rod and said arm can be considered in turn as a single structural restraint element between the lever and the braking tooth. All the components described, apart from the cable, are preferably made of metallic materials.

The features of the present invention will be made clearer by the following detailed description relating to a possible embodiment of the same provided by way of a non-limiting example of the more general concepts claimed.

### BRIEF DESCRIPTION OF THE DRAWINGS

The following description refers to the accompanying drawings, in which:

FIG. 1 is a front view of the present invention in such a configuration that the cable can slide freely;

FIG. 2 is a front view of the present invention in configuration of blocking of the cable or on the cable with the regulation lever released;

FIG. 3 is a front view of the present invention in configuration of blocking of the cable or on the cable with the regulation lever gripped by the user;

FIG. 4 is a front view of the present invention explaining the operation of recovery of the cable for the purpose of ascent of the user;

FIG. 5 is a side view of the shackle with which the present invention is provided;

FIG. 6 is a perspective view of the shackle with which the present invention is provided.

### DETAILED DESCRIPTION OF THE INVENTION

Referring to the drawings, the regulation lever 7 is constrained with known means via the pin 11 to rotate in the plane of the support flange 8, so as to induce the equivalent rotation of the lower cam 9, also integral with said pin 11. The upper cam 10 is instead attached completely to the support flange 8 via the support 12 by known means. Said cams are preferably provided with appropriate holes intended to save material.

The lower cam is preferably provided with a certain eccentricity in relation to the pin 11, while the upper cam 10 is preferably in the form of a pulley. The surface of at least one of said cams 9 and 10 is at least in part curved towards the interior of the cam in order to ease the sliding of the cable 27 or increase the friction with it, and is also preferably provided with appropriate grooves in order to increase the friction with said cable 27.

The connecting rod 18 is hinged by means of the pin 17 to the arm 15 of the shackle 13, the latter also composed of the braking tooth 14 integral with said arm 15 and constrained together with it to rotate around the pin 16 integral with the support flange 8. Said connecting rod 18 is restrained to the regulation lever 7 with another pin not visible in the drawings, and is provided with a slight curvature 19 created to follow the corresponding curvature 20 of the support flange 8, said curvature 20 being intended to lower the zone of the support flange 8 adjacent to said arm 15, to ease further the operation of recovery of the cable 27.

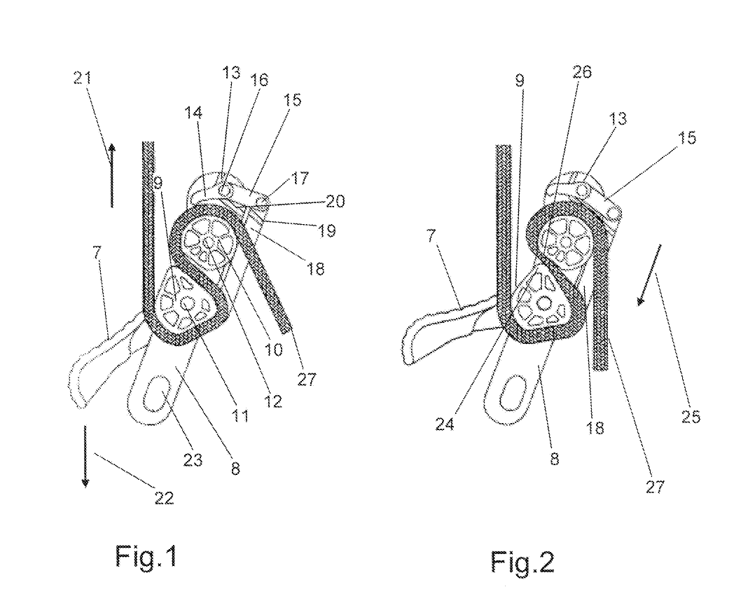

As can be seen in the drawings, with the regulation lever 7 in the intermediate position of FIG. 1 the cable 27 can slide freely along the arrow 21 so that the user, attaching himself or herself to the device also preferably by means of a rope restrained on one side to the hole 23 and on the other to the body of said user, can slow down his or her descent, generally moving along the arrow 22 in the direction of gravity, thanks to the friction between the cable and the assembly created by the cams 9 and 10 and by the support flange 8.

If the regulation lever 7 is released, as shown in FIG. 2, it moves away from the support flange 8 and the very curved protuberance 24 of the lower cam 9 crushes the cable 27 against a preferably fairly flat side 26 of the upper cam which remains fixed in relation to the support flange 8, so as to wedge and block the cable 27 between said two cams.

The rotation of the regulation lever 7 externally in relation to the support flange 8 induces the transition of the connecting rod 18 along the arrow 25, causing the rotation downwards of the arm 15, while in the previous mechanisms it caused the blocking of the cable between the upper cam and the braking tooth which was present in place of this arm 15, which in the present invention is less thick and not able to block said cable 27.

Said protuberance 24 is preferably provided with appropriate grooves which increase the friction between the lower cam 9 and the cable 27.

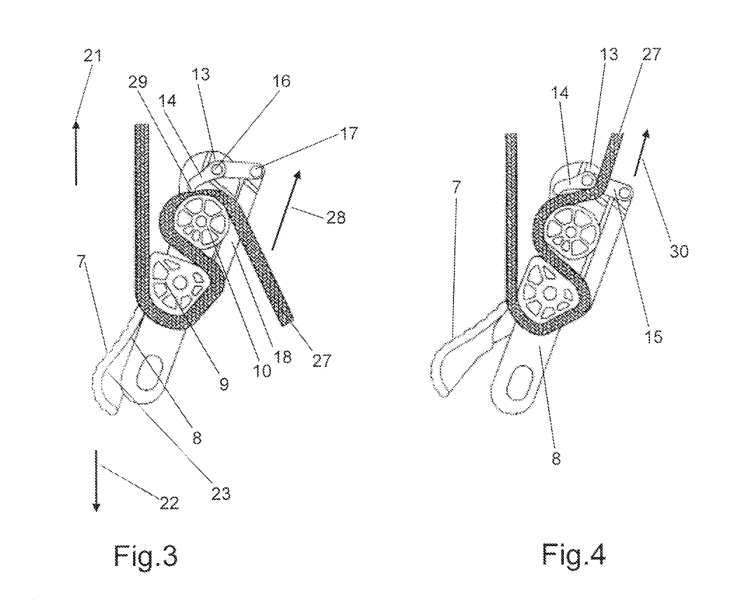

If the user instead rotates the regulation lever 7 towards the support flange 8, as shown in FIG. 3, the connecting rod 18 transitions along the arrow 28 and thanks to the pin 17 induces the rotation, anticlockwise in this drawing, of the shackle 13 around the pin 16, crushing therefore the sharp part 29, almost an edge, of the braking tooth 14 against the cable, so that the latter is wedged, jamming itself between the upper cam 10 and said braking tooth 14.

Considering again the regulation lever 7 in intermediate position, at the moment when the cable 27 is to be recovered in order to ascend,. the latter can be pulled along the arrow 30, positioning as in FIG. 4, without said cable 27 exerting torque on the shackle 13 such as to rotate the braking tooth 14 and maintain it in position of blocking of said cable 27. In fact said cable 27 succeeds easily in passing over the arm 15 without significantly influencing the position of the shackle 13.

The braking tooth 14 can be equipped with a rotating element suitable for further reducing the friction of the cable 27 on the braking tooth 14 at the time of recovery of the cable 27 itself.

The device is preferably equipped with a further front protection flange, also inserted around the pin 11 between the head of the same and the lower cam 9, preferably rotating around this pin 11 and intended to prevent the exit of the cable from the device in an approximately perpendicular direction to the surface of the support flange 8.

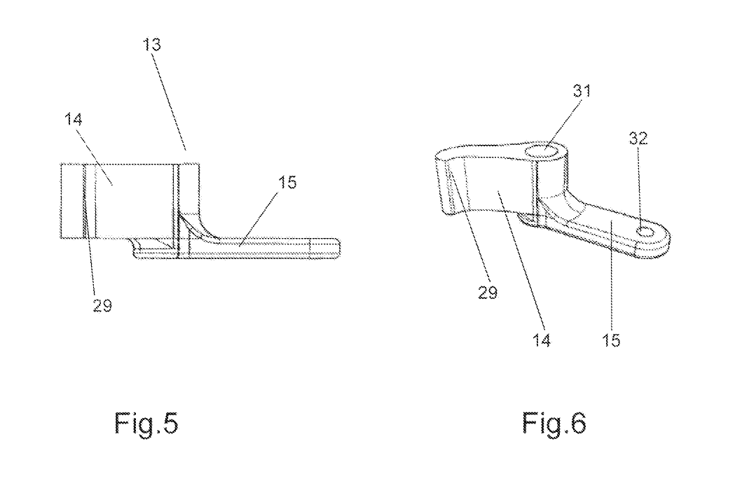

FIGS. 5 and 6 show the shackle 13, which has the two parts 14 and 15 whereof the first extends more in the direction of the axis of rotation of said shackle around the restraint pin with the support flange which is inserted in the hole 31. The restraint pin with the connecting rod is instead inserted in the hole 32.

Variations in composition in relation to what is described are possible, in any case coming within the scope of protection of this patent for utility model.

For example more than two cams could be used, at least one of the latter could be a single body with the support flange or they could be both rotating in relation to said support flange, the function whereof could moreover be performed by a body not exactly comparable to a flange.

The structural element of restraint between regulation lever and braking tooth could be composed of bodies having roughly the same functions of the assembly created by connecting rod and arm but be of a different shape.

What is claimed is:

1. A descender intended preferably for the descent of a user along a cable comprising:
at least one support flange
at least two cams
at least one body structurally comparable to a tooth
at least one lever
at least one structural element of restraint between said at least one body structurally comparable to a tooth and said at least one lever,
said at least two cams and at least one body structurally comparable to a tooth being restrained at least partially to said at least one support flange and defining a curved path, by means of at least two recesses on said at least one support flange, one between said at least two cams and one between one of said at least two cams and said at least one body structurally comparable to a tooth, preferably at least partially S-shaped and intended to slow down the transition of the cable due to friction between said cable and said cams,
said at least one body structurally comparable to a tooth and at least one of said two cams each being rotated by means preferably of a pin in relation to said support flange,
said at, least one lever being integral via known means with said at least one of said two cams which can rotate in relation to the at least one support flange, so that a rotation of said at least one lever in relation to said at least one support flange corresponds to at least:
a rotation of at least one of said two cams which can rotate in relation thereto
a roto-translation of said at least one structural element of restraint, or
a rotation of said tooth,
wherein: said at least one structural element of restraint is made up of at least two parts restrained via known means to one another in order to be able to rotate reciprocally, at least one of said at least two parts being restrained also to said at least one lever and being rotating in relation thereto, the other being integral with said at least one body structurally comparable to a tooth and having in relation thereto a smaller extension along the axis of rotation of the same around said at least one support flange;
said part integral with said at least one body structurally comparable to a tooth allows the user to pull a cable, adjacent at least partially to each of said at least two cams and arranged in such a way as to cover said approximately S-shaped path, externally in relation to said at least one recess defined by the at least one body structurally comparable to a tooth and of at least one cam, in order to recover the cable and ascend along it, making the same cable slide on that part integral with said at least one body structurally comparable to a tooth without making the same tooth rotate significantly, hence avoiding wedging said cable inside said at least one recess;
at least one of said at least two cams is provided with a fairly curved protuberance thanks to which said cable can be wedged, and therefore blocked in the at least one recess defined by said at least two cams, via an appropriate rotation of said at least one lever and therefore also of said at least one of said two cams each being rotated, in relation to the at least one support flange.

2. The descender intended preferably for the descent of the user along a cable according to claim 1, wherein in at least one of said at least two cams is integral with the support flange via known means.

3. The descender intended preferably for the descent of the user along a cable according to claim 2, wherein said at least one of said at least two cams integral with the support flange is made up of a body in the form of a pulley.

4. The descender intended preferably for the descent of the user along a cable according to claim 1, wherein at least part of an outer surface of at least one of said at least two cams has a concavity turned towards the interior of said at least one of said at least two cams so as to facilitate a sliding of the cable.

5. The descender intended preferably for the descent of the user along a cable according to claim 1, wherein said protuberance which allows a wedging of the cable between said at least two cams is situated on said at least one of said two cams integral with the at least one lever.

6. The Descender intended preferably for the descent of the user along a cable according to claim 1, wherein on at least one of said at least two cams at least one groove is formed, intended to ease the wedging of the cable between said at least two cams by means of said protuberance.

7. The descender intended preferably for the descent of the user along a cable according to claim 1, wherein the at least one of said at least two parts, relative to said structural element of restraint between said at least one body structurally comparable to a tooth and said at least one lever, is a connecting rod hinged to the other at least one of said at least two parts and to said at least one lever.

8. The descender intended preferably for the descent of the user along a cable according to claim 2, wherein a rotation of said at least one lever in one direction causes the rotation of said at least one of said two cams integral with said at least one lever so that said protuberance can approach another cam in relation to that upon which said protuberance is situated so as to block the cable, wedging the cable between said at least two cams, while a rotation of said at least one lever in an opposite direction causes at least the approaching of the at least one body structurally comparable to a tooth to said cam which is integral in relation to the support flange so as to wedge said cable, to jam between the at least one body structurally comparable to a tooth and said at least one of said two cams, at least one of said processes being able to take place by means of said roto-translation of said at least one structural element of restraint between said at least one body structurally comparable to a tooth and said at least one lever.

9. The descender intended preferably for the descent of the user along a cable according to claim 1, wherein the descender has at least one protection flange restrained with known means to at least one of said two cams, said at least one protection flange being rotated in relation to said at least one of said two cams and intended to prevent the cable from exiting said at least one recess in a direction perpendicular to said at least one support flange.

10. The descender intended preferably for the descent of the user along a cable according to claim 1, wherein at least one of the descender's component elements is at least partially made up of a metallic material.
